(19) United States
(12) Patent Application Publication
(10) Pub. No.: US 2016/0307010 A1
(43) Pub. Date: Oct. 20, 2016

(54) SYSTEMS AND METHODS FOR TUNING AN ANTENNA OF A MOBILE COMPUTING DEVICE

(71) Applicant: HAND HELD PRODUCTS, INC., Fort Mill, SC (US)

(72) Inventors: Fengyu GE, Cedar Rapids, IA (US); Thomas John SCHUSTER, Cedar Rapids, IA (US); Paul HULETT, Mediapolis, IA (US)

(21) Appl. No.: 14/688,592

(22) Filed: Apr. 16, 2015

(51) Int. Cl. G06K 7/10; G06F 17/30; H04W 4/00

(52) U.S. Cl. CPC G06K 7/10326; H04W 4/008; G06F 17/30876; G06K 7/10386

(57) ABSTRACT

A system and method for tuning are provided. One system includes at least one antenna, at least one matching network configured to retune the at least one antenna when a peripheral device is coupled to the system and a processor configured to identify the peripheral device when coupled with the system. The system also includes a controller configured to control switching of the at least one matching network based on when the peripheral device is coupled with the system.

### BACKGROUND

Handheld or mobile computing devices are widely used, such as in different field mobility environments. For example, these computing devices may be used by mobile field service and transportation workers to allow different types of mobile operations, such as in-field computing, radio frequency identifier (RFID) scanning, barcode scanning, and communication with remote external devices, among others.

These mobile computing devices typically include communication systems with antennas that need to be tuned to the operating environment in order to provide proper operation and acceptable performance. However, due to various limitations, mobile antennas, such as antennas for use with these mobile computing devices, are typically tuned to free space.

These mobile computing devices are becoming increasingly more advanced and include additional functionality for use in different operating environments and in combination with different peripheral devices. For example, mobile computing devices, including handheld computers, are often used with peripheral devices such as protective cases, scan handles and docking stations, among others, which can provide increased functionality or benefits to the mobile computing devices. The peripheral devices, when connected with the mobile computing devices, often detune the antenna(s) within the mobile computing devices. The detuning effects can cause communication performance issues, such as radio performance degradation, and in some instances, loss of communication.

Systems are known for tuning mobile antennas. Some of these systems include auto-tuning mechanisms that approximate certain detuning effects and attempt to automatically retune the antenna to its environment. However, these known tuning systems with auto-tuners are not capable of tuning the antenna(s) for operation with some peripheral devices, such as peripheral devices that may be attached to mobile computing devices. In other instances, the approximate tuning of the auto-tuners cannot provide the needed optimal antenna tuning to attached peripheral devices to allow satisfactory operation because of lack of accurate knowledge of the environment, including accurate knowledge of the peripheral device attached to the mobile computing device. Moreover, these systems are not only typically complex, requiring increased processing power to compute and compensate for the different possible detuning effects, but also have limited tuning ranges.

### SUMMARY

To overcome these and other challenges, aspects of broad inventive principles are disclosed herein.

In one embodiment, a system is provided that includes at least one antenna, at least one matching network configured to retune the at least one antenna when a peripheral device is coupled to the system and a processor configured to identify the peripheral device when coupled with the system. The system also includes a controller configured to control switching of the at least one matching network based on when the peripheral device is coupled with the system.

In another embodiment, a mobile computing device is provided that includes at least one antenna, at least one non-auto-tuning device configured to retune the at least one antenna when a peripheral device is coupled to the system and a processor configured to identify the peripheral device when coupled with the system. The system also includes a controller configured to control the at least one non-auto-tuning device based on when the peripheral device is coupled with the system.

In another embodiment, a method is provided that includes providing plural preconfigured matching networks with the mobile computing device, wherein the plural preconfigured matching networks are configured based on one or more known electrical properties of one or more peripheral devices to be coupled to the mobile computing device that detune the mobile computing device. The method also includes configuring a controller within the mobile computing device to identify a peripheral device coupled to the mobile computing device and select one or more of the plural matching networks based on the identified peripheral device to retune one or more antennas within the mobile computing device when the peripheral device is coupled with the mobile computing device.

### BRIEF DESCRIPTION OF THE DRAWINGS

FIG. 1 is a block diagram illustrating a system according to one embodiment.

FIGS. 2A, 2B and 2C schematically illustrate an RFID apparatus according to one embodiment.

FIG. 3 is a block diagram of a network-level layout of a data collection system utilizing one or more RFID apparatus according to one embodiment.

FIG. 4 is a block diagram of a component-level layout of an RFID apparatus according to one embodiment.

FIG. 5 is a diagram of a mobile computing device according to one embodiment coupled with a peripheral device.

FIG. 6 illustrates a method for tuning a mobile computing device according to one embodiment.

### DETAILED DESCRIPTION

The exemplary embodiments described herein provide detail for illustrative purposes and are subject to many variations in structure and design. It should be appreciated, however, that the embodiments are not limited to a particularly disclosed embodiment shown or described. It is understood that various omissions and substitutions of equivalents are contemplated as circumstances may suggest or render expedient, but these are intended to cover the application or implementation without departing from the spirit or scope of the claims.

Also, it is to be understood that the phraseology and terminology used herein is for the purpose of description and should not be regarded as limiting. The terms “a,” “an,” and “the” herein do not denote a limitation of quantity, but rather denote the presence of at least one of the referenced object. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Furthermore, as will be appreciated by one skilled in the art, aspects of the present disclosure may be embodied as a system, method, or computer program product. Accordingly, aspects of various embodiments may take the form of an entirely hardware embodiment, an entirely software embodiment (including firmware, resident software, micro-code, etc.) or an embodiment combining software and hardware aspects that may all generally be referred to herein as a “circuit,” “module”, “system” or “subs-system.” In addition, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM) or similar DVD-ROM and BD-ROM, an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

At least some of the present disclosure is described below with reference to flowchart illustrations and/or block diagrams of methods, apparatus (systems) and computer program products according to embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Handheld or mobile computing devices can be used in many different applications. Accordingly, while various embodiments may be described in connection with identifying items or inventory in a particular environment, the various embodiments are not so limited. For example, various embodiments may be used to identify or locate different types of RFID tags or items to which RFID tags are coupled. Additionally, the handled or mobile computing devices may be used in many different commercial or industrial applications.

When peripheral devices are connected to the handled or mobile computing device, detuning of one or more antennas of the handled or mobile computing device can occur. Accordingly, without proper retuning, performance of the handled or mobile computing devices may be degraded, which in some cases includes a total loss of communication.

Some embodiments of the present application describe systems and methods to facilitate retuning of one or more antennas of handled or mobile computing devices, which overcome the difficulties and limited benefits of auto-tuning or automatic tuner systems. In various embodiments, knowledge of the environment, such as a priori knowledge of a peripheral device attached to the handled or mobile computing device is used in a retuning process. For example, information relating to the attached peripheral devices may be determined from identification devices installed with the peripheral devices, which then may be used with the a priori knowledge to retune one or more antennas in the handled or mobile computing device. In some embodiments, a process is performed that results in an optimal tuning based on the particular or specific peripheral device attached to the handled or mobile computing device.

More particularly, various embodiments provide a tuning arrangement that does not use an autotune mechanism, but uses an arrangement wherein one or more predefined matching networks are selected for retuning, which may include one circuit for each peripheral device that may be attached to the handled or mobile computing device. In operation, by knowing what type of peripheral device is attached to the handled or mobile computing device, such that the configuration, operating characteristics, etc. then may be determined based on a priori knowledge, one or more tuning circuits (which may form part of one or more matching networks) can be set to match the characteristics of peripheral device(s) to achieve optimal antenna tuning.

It should be appreciated that the tuning elements in the tuning/matching circuit are not limited to particular components, such as lumped elements, including capacitors and inductors. Instead, the tuning elements can also include other components, such as transmission lines, parasitic elements, grounding structures and microchips, among others, to tune for the effects of attached peripheral devices that otherwise cannot be practically tuned by an autotuner. In some embodiments, the tuning elements in the tuning/matching circuit do not include any capacitors or inductors. Accordingly, in various embodiments, the systems and methods provide retuning to maintain radiation efficiency, but do not change the radiation pattern.

The various embodiments, including the use of one or more tuning/matching circuits in some embodiments can provide exact optimal antenna tuning to one or more attached peripherals. Additionally, the design is of low complexity due to in part to the fixed number of tuning scenarios (e.g., the fixed set of peripheral devices that may be attached or are compatible with the handled or mobile computing device), and therefore more practical for these devices, compared to autotuner systems. Moreover, using one or more embodiments described herein, there is no limitation of tuning range, unlike autotuner systems.

It should also be appreciated that the types of peripheral devices and information obtained related to these devices may be varied as desired or needed. For example, based on the particular operating requirements or environment, different types or subsets of information relating to the peripheral devices may be used for retuning in accordance with various embodiments.

Thus, in various embodiments, a priori knowledge determined or associated with a particular peripheral device may be collected and used to retune the antenna to provide an optimal tuning arrangement with the attached peripheral device. It should be understood that various embodiments may operate in different settings or may be used for different applications. Additionally, the manner and format in which the identification information is acquired from the peripheral device, as well as the manner and format in which the a priori information is stored may be varied as desired or needed.

It should be noted that while various embodiments are described in connection with a mobile computing device configured as an RFID tag location system including various components, the embodiments may be implemented in connection with any type of mobile computing device. Accordingly, the various components are referred to herein for ease of illustration. It should further be understood that the system and various components may be configured as any type of mobile computing system, such as different types of RFID scanning systems.

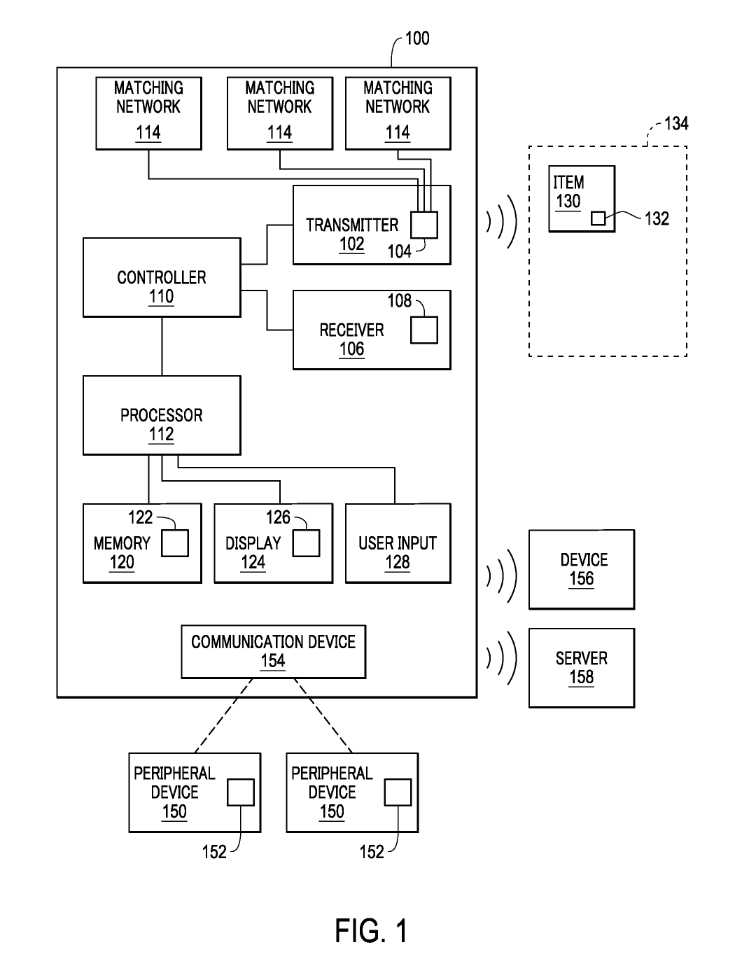

One embodiment of a mobile computing system 100, which may be configured as an RFID tag scanning system, is shown in FIG. 1. The system 100 may be embodied as or form part of a handheld RFID scanner that is capable of connection to one or more peripheral devices 150. For example, the system 100 may be embodied or form part of a mobile computing device, such as an Intermec mobile computer available from Honeywell Scanning and Mobility.

It should be appreciated that the system 100 may be configured to allow one or more than one of the peripheral devices 150 to be coupled with the system 100 at the same time. Additionally, different coupling arrangements may be used to couple one or more of the peripheral devices 150 to the system 100, which may be a direct connection or indirect connection, such as through an intermediate interface device (e.g., a multi-pin to multi-pin interface device). Accordingly, the peripheral devices 150 may be in direct contact with a housing (not shown in FIG. 1) of the system 100 or in indirect contact with the housing.

The RFID tag location system 100 can comprise a transmitter 102 having one or more transmit antennas 104 and a receiver 106 having one or more receive antennas 108. It should be noted that although one transmit antenna 104 and one receive antenna 108 are illustrated, the system 100 can comprise additional transmit or receive antennas 104, 108. In one or more embodiments, a plurality of receive antennas 108 are arranged in an array, which may be symmetrical or asymmetrical. For example, the receive antennas 108 may be arranged in a generally rectangular array configuration or aligned to form different sized and shaped arrays as desired or needed, such as based on the RFID tags to be scanned. The transmitter 102 and receiver 106 may be selectively activated (e.g., selectively turned on and off) to scan a region of interest 134 to acquire RFID tag information from an RFID tag 132 coupled with an item 130. Additionally, it should be appreciated that the transmitter 102 and receiver 106 are not limited to communication with RFID tags 132, but may be configured to provide communication with other devices (e.g., a radio communication device 156), systems, a server 158, etc.

It also should be noted that the system 100 may include at least one antenna, which may be embodied as the transmit or receive antenna 104, 108, or a different antenna.

The system 100 can also comprise a controller 110 coupled to the transmitter 102 and receiver 106. It should be noted that any type of communicative or operative coupling may be used, such as any type of wireless or wired communication. The controller 110 is configured to control the operation of the transmitter 102 and receiver 106, such as to control the transmissions by the transmit antenna 104 and the reception by the receive antennas 108, as well to control tuning, including retuning of one or more antennas, such as the transmit and/or receive antennas 104, 108 to maintain radiation efficiency of the antenna(s).

It also should be noted that while the system 100 is described based on an RFID reader configuration, and the matching networks are also described as to retune the RFID antennas, various embodiments are not limited to RFID systems and tuning RFID antennas. For example, one or more embodiments, including the system 100 may be embodied or configured for operation as a cellular (e.g., WWAN) system, a WLAN system, a Bluetooth system, and/or a GPS system, among others. In general, various embodiments may be configured to allow tuning or retuning of one or more antenna (which may be of any type) installed in mobile or handheld devices that may be degraded by peripheral devices.

In one embodiment, the controller 110 is a transmit and receive controller configured to control the radio-frequency (RF) pulses sent to the transmit antenna 102 and the communication of signals received by the receive antennas 108. However, as described in more detail herein, the controller is also configured to control other components of the system 100 or control the antenna(s) to provide different operations.

The system 100 can further comprise a processor 112 coupled to the controller 110. As described in more detail herein, the processor 112 can control the operation of the controller 110 to transmit and receive as desired or needed, including retuning of the transmit and/or receive antennas 104, 108 based on one or more peripheral devices 150 coupled with the system 100. For example, plural matching networks 114 (three are shown only for illustration, and more or less may be provided) may be controlled by the controller 110 based on a priori information relating to the one or more attached peripheral devices 150.

It should be noted that the plural matching networks 114 may include any type of tuning/matching circuit as described in more detail herein and be provided within the system 100 (e.g., within the handheld computing device). Each of the plural matching networks 114 may correspond to a particular peripheral device 150 or multiple peripheral devices 150. Additionally, a combination of the plural matching networks 114 may correspond to one or more of the peripheral devices 150. For example, the plural matching networks 114 in various embodiments are configured as predefined matching circuits to retune one or more antennas, such as the transmit and/or receive antennas 104, 108 to optimize tuning, such that a radiation efficiency is maintained. Thus, the characteristics of the plural matching networks 114 are configured based on the particular peripheral device 150 (such as the known electrical properties of the peripheral devices 150), such that when the peripheral device 150 is coupled with the system 100, the transmit and/or receive antennas 104, 108 are retuned when one or more the plural matching networks 114 is selected (e.g., connected with the transmitter 102). Thus, the plural matching networks 114 may be switched in and out of the antenna circuit of the transmit and/or receive antennas 104, 108. As discussed above, for example, if the electrical properties of two different peripheral devices 150 are similar or within a predetermined variance range, the same matching network 114 may be used to retune the transmit and/or receive antennas 104, 108.

The processor 112 is also configured in various embodiments to process received identification information from the peripheral devices 150, which may be acquired from an identification component 152 within or coupled to the peripheral devices 150, such as a feedback circuit that provides identification information that allows the processor to determine the specific peripheral device 150 coupled with the system 100. Different types of identification components 152 may be used, for example a Near-Field Communication (NFC) tag, a Bluetooth Low Energy chip, or an optical device, among others.

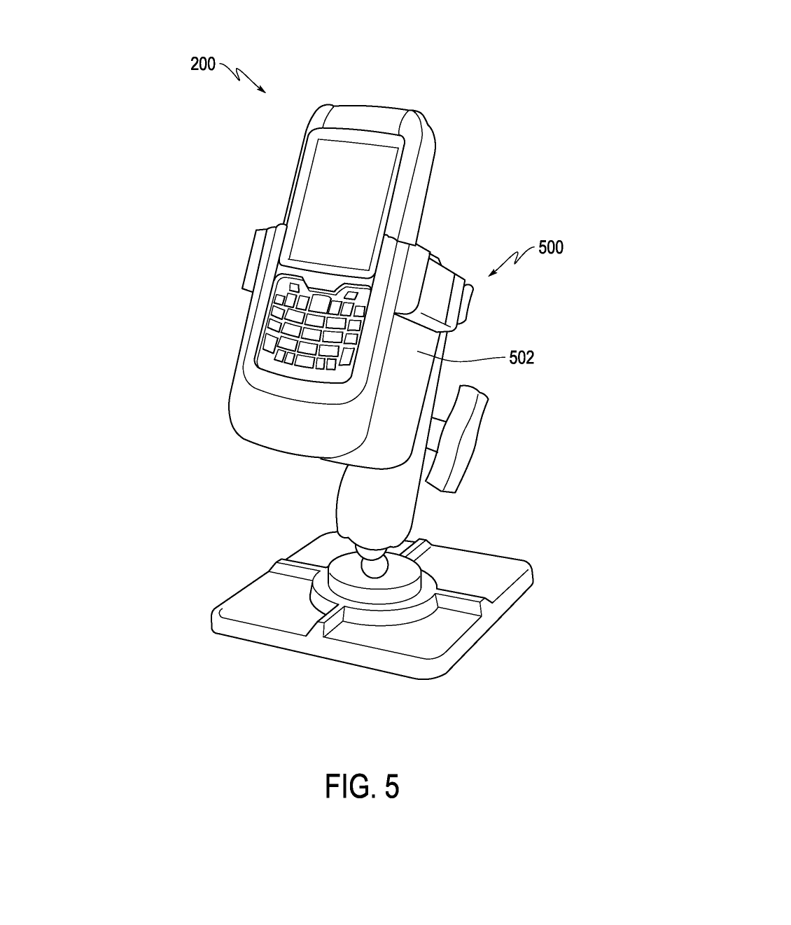

The system 100 includes a communication device 154 configured to communicate with the identification component 152 of the peripheral device 150 to acquire the identification information. For example, if the peripheral device 150 is a vehicle dock 500 (shown in FIG. 5) with a built-in NFC tag, when the vehicle dock is coupled with the system 100 (which may be embodied as an RFID apparatus 200 as shown in FIG. 5), the communication device 154, which in this example is an NFC radio in the system 100, will read the NFC tag to determine the specific type or model of the vehicle dock 500 coupled with the system 100. Once the specific type or model of the vehicle dock 500 is determined, the processor 112, using a priori knowledge of the specific type or model of the vehicle dock 500 (including the electrical properties of the specific type or model of the vehicle dock 500) causes the controller 110 to select and switch “on” or “off” one or more corresponding matching networks 114.

It should be appreciated that in some embodiments, the controller 110 may automatically switch on one or more of the matching networks 114 to retune the transmit and/or receive antennas 104, 108 based on the known operating characteristics and/or detuning effects of the attached peripheral device 150.

Referring again to the system 100, a memory 120, which may be any type of electronic storage device, can be coupled to the processor 112 (or form part of the processor 112). The processor 112 may access the memory 112 to obtain stored peripheral device information 122 that corresponds to or is associated with the identified attached peripheral device 150, such that a determination then may be made as to which one or more of the matching networks 114 is to be turned on as described in more detail herein.

The system 100 can comprise a display 124 and a user input device 128 coupled to the processor 112 to allow user interaction with the system 100. For example, the display 124 can allow display of the peripheral device identification information to the user or provide information relating to a scanned RFID tag 132. It should be noted that in some embodiments, the display 122 and user input device 124 may be integrated, such as in a touchscreen display device.

While FIG. 1 illustrates a particular connection arrangement of the various components, a skilled artisan would appreciate the fact that other connection arrangements may be made that are within the scope of this disclosure. Additionally, the various components may be housed within the same or different physical units and the separation of components within FIG. 1 is merely for illustration.

The system 100 can also comprise one or more communication subsystems (in addition to the communication device 154) to allow communication with external devices, such as networks, printers, etc. that are not coupled with the system 100 in such a way to cause detuning effects to the antennas. Thus, additional components may form part of or communicate with the system 100.

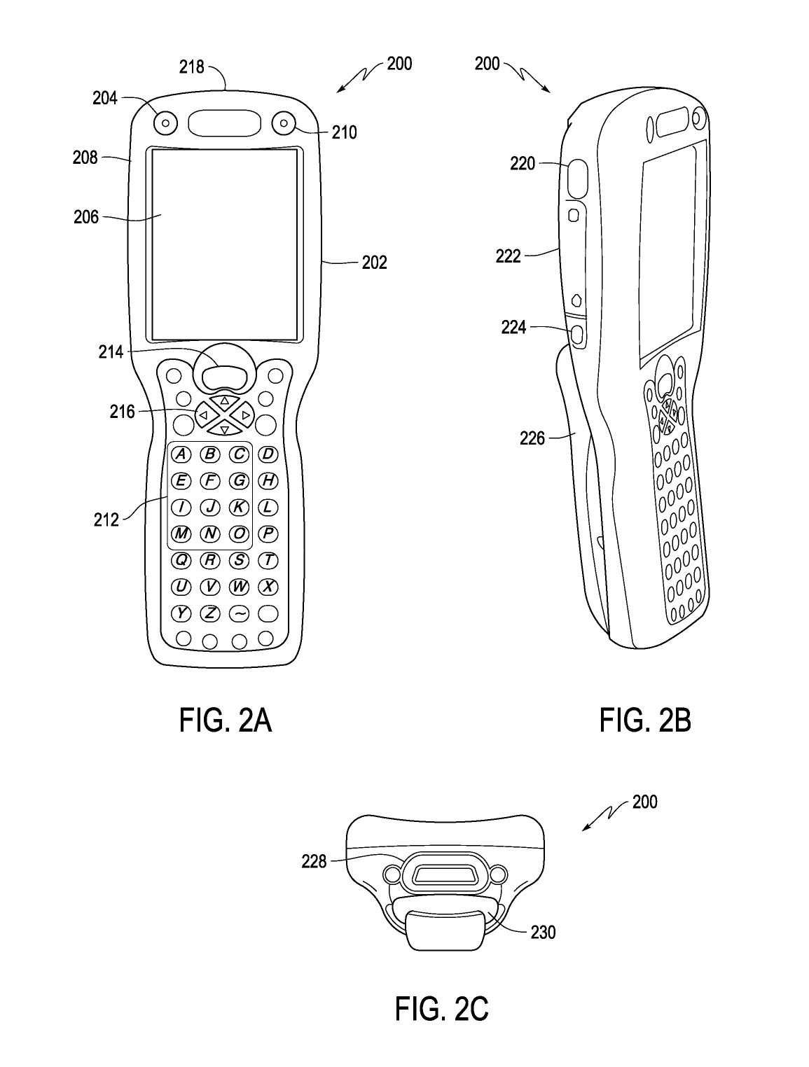

In some embodiments, the system 100 may be embodied as part of a RFID apparatus 200 is shown in FIGS. 2A (front panel view), 2B (oblique panel view) and 2C (bottom panel view). The RFID apparatus 200 can comprise a housing 202 within which other components of RFID reader 200 can be disposed. An LCD screen display with touch screen sensor 206 can be disposed on a front panel 208. Also disposed on the front panel 208 can be an operation LED 204, a scan LED 210, and keyboard 212 including a scan key 214 and navigation keys 216. An imaging window 218 can be disposed on the top panel of the housing 202. Disposed on the side panel (best viewed in FIG. 2B) can be an infrared communication port 220, an access door to a secure digital (SD) memory interface 222, an audio jack 224, and a hand strap 226. Disposed on the bottom panel (best viewed in FIG. 1C) can be a multi-pin mechanical connector 228 and a hand strap clip 230.

In various embodiments, the imaging window 218 allows an imaging system, such as the imager 114 (shown in FIG. 1) within the housing 202 to be behind the imaging window 218 for protection to have a field of view in front of the RFID apparatus 200. In some embodiments, an illuminator (not shown) may also be disposed within housing 202 behind the protective imaging window 218 in a cooperative manner with the camera system. In one embodiment, the imaging window 218 may include a fisheye lens or other lens to provide a panoramic or wider view to ensure that a camera can capture images of, for example, the region of interest 134 (shown in FIG. 1).

Also disposed on the bottom panel (or alternatively on the top panel) can be an RFID antenna housing and an RFID read device (which may can include the transmitter 102 and receiver 106 shown in FIG. 1) within the housing 202.

While FIGS. 1A-1C illustrate one embodiment of a handheld housing, a skilled artisan would appreciate that other types and form factors of terminal housings are within the scope of this disclosure. Additionally, different portions of the housing 202 may be configured to couple with one or more of the peripheral devices 150 (shown in FIG. 1), such as via a snap-fit or other compatible physical connection.

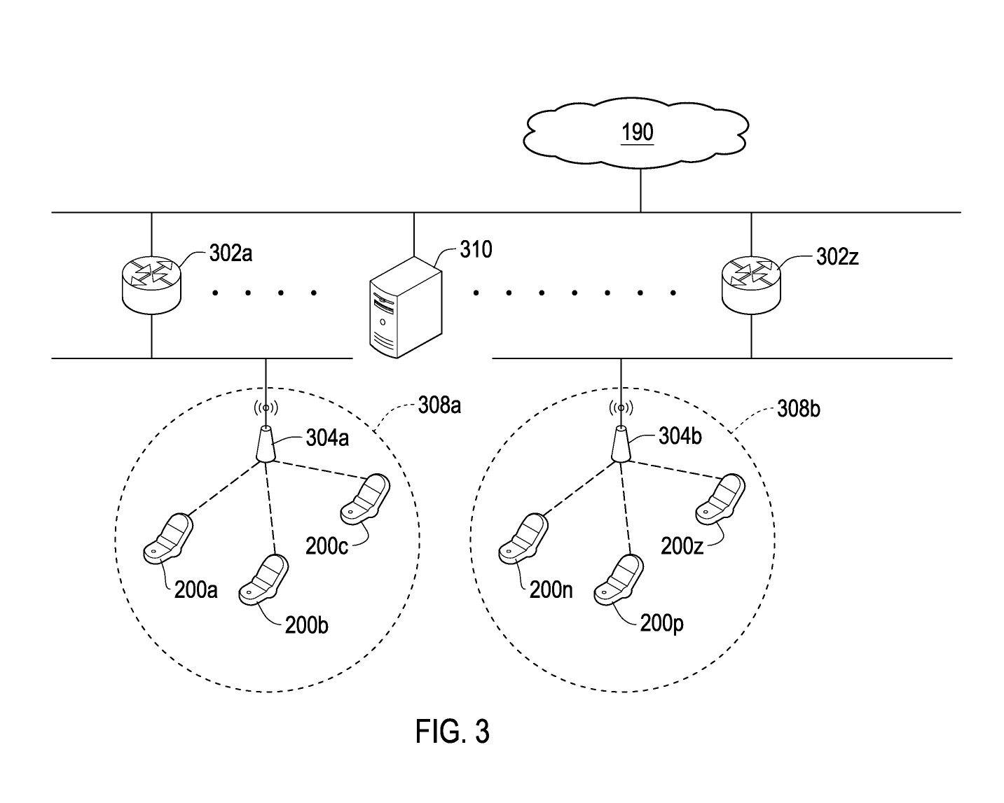

In some embodiments, the system 100 and/or RFID apparatus 200 can be incorporated in a data collection system. The data collection system, schematically shown in FIG. 3, can include a plurality of routers 302a-302z, a plurality of access points 304a-304, and a plurality of RFID apparatus 200a-200z in communication with a plurality of interconnected networks 308a-308z. In one embodiment, the plurality of networks 308a-308z can include at least one wireless communication network. In one or more embodiments, one or more of the RFID apparatus 200 can comprise a communication interface which can be used by the RFID apparatus 200 to connect to the one or more of the networks 308a-308z. In one embodiment, the communication interface can be provided by a wireless communication interface.

One or more of the RFID apparatus 200 can establish communication with a host computer 310. In one embodiment, network frames can be exchanged by the RFID apparatus 200 and the host computer 310 via one or more routers 302, base stations, and other infrastructure elements. In another embodiment, the host computer 310 can communicate with the RFID apparatus 200 via a network 308, such as a local area network (LAN). In yet another embodiment, the host computer 310 can communicate with the RFID apparatus 200 via a network 308, such as a wide area network (WAN). A skilled artisan should appreciate that other methods of providing interconnectivity between the RFID apparatus 200 and the host computer 310 relying upon LANs, WANs, virtual private networks (VPNs), and/or other types of network are within the scope of this disclosure.

In one embodiment, the communications between the RFID apparatus 200 and the host computer 310 can comprise a series of HTTP requests and responses transmitted over one or more TCP connections. In one embodiment, the communications between the RFID apparatus 200 and the host computer 310 can comprise VoIP traffic transmitted over one or more TCP and/or UDP ports. A skilled artisan should appreciate that using other transport and application level protocols is within the scope of this disclosure.

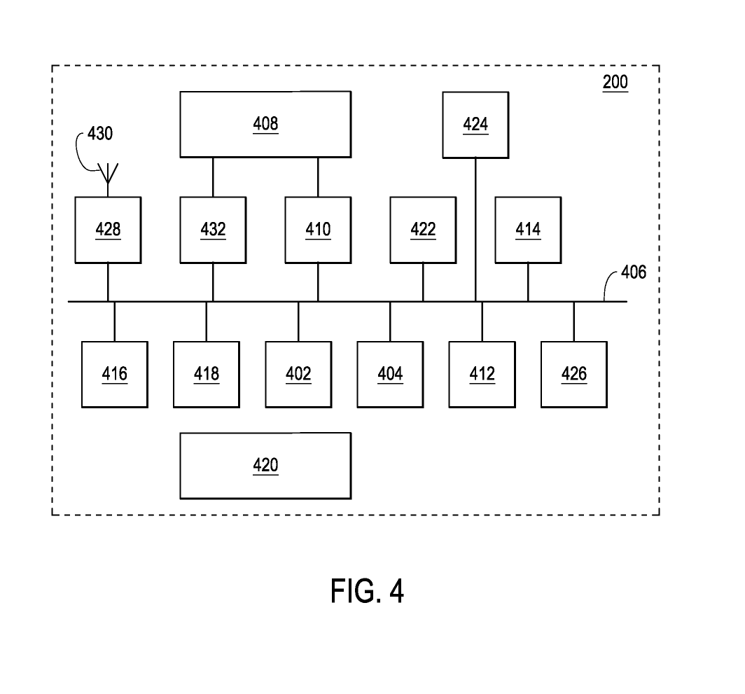

A component-level diagram of one embodiment of an RFID apparatus 200 will now be described with reference to FIG. 4. The RFID apparatus 200 can comprise at least one microprocessor 402 and a memory 404 (which may be embodied as the memory 120 shown in FIG. 1), both coupled to a system bus 406. The microprocessor 402 can be provided by a general purpose microprocessor or by a specialized microprocessor (e.g., an ASIC). In one embodiment, the RFID apparatus 200 can comprise a single microprocessor which may be referred to as a central processing unit (CPU). In another embodiment, the RFID apparatus 200 can comprise two or more microprocessors, for example, a CPU providing some or most of the RFID apparatus functionality and a specialized microprocessor performing some specific functionality (e.g., tag location determination as described herein). A skilled artisan should appreciate that other schemes of processing tasks distributed among two or more microprocessors are within the scope of this disclosure. The memory 404 can comprise one or more types of memory, including but not limited to random-access-memory (RAM), non-volatile RAM (NVRAM), etc.

The RFID apparatus 200 can further comprise a communication interface 408 communicatively coupled to the system bus 406. In one embodiment, the communication interface 408 may be by a wireless communication interface. The wireless communication interface can be configured to support, for example, but not limited to, the following protocols: at least one protocol of the IEEE 802.11/802.15/802.16 protocol family, at least one protocol of the HSPA/GSM/GPRS/EDGE protocol family, TDMA protocol, UMTS protocol, LTE protocol, and/or at least one protocol of the CDMA/IxEV-DO protocol family.

A module 410 is an additional modular component that can be replaced with upgraded or expanded modules and is coupled between the system bus 308 and the communication interface 408. This module 410 is compatible with, for example, auxiliary hard drives (including flash memory), RAM, communication interfaces, etc.

The RFID apparatus 200 can further comprise a camera system 412 and an image interpretation and processing module 414. In one embodiment, the image interpretation and processing module 414 receives image data from the camera system 412 and processes the information for use in determining the location of one or more RFID tags and presenting an image corresponding to that determined location. In another embodiment, the processing module 414, which is coupled to the system bus 406, exchanges data and control information with the microprocessor 402 or the memory 404.

The RFID apparatus 200 can further comprise a keyboard interface 416 and a display adapter 418, both also coupled to the system bus 406. The RFID apparatus 200 can further comprise a battery 420. In one embodiment, the battery 420 may be a replaceable or rechargeable battery pack.

The RFID apparatus 200 can further comprise a GPS receiver 422 to facilitate providing location information relating to the RFID apparatus 200. The RFID apparatus 200 can also comprise at least one connector 424 configured to receive, for example, a subscriber identity module (SIM) card. The RFID apparatus 200 can further comprise one or more illuminating devices 426, provided by, for example, but not limited to, a laser or light emitting diode (LED). The RFID apparatus 200 still further can comprise one or more encoded indicia reading (EIR) devices 428 provided by, for example, but not limited to, an RFID reading device, a bar code reading device, or a card reading device. In one embodiment, the RFID apparatus 200 can be configured to receive RFID scanning information, such as responses received from activated RFID tags.

It should be appreciated that devices that read bar codes, read RFID tags, or read cards bearing encoded information may read more than one of these categories while remaining within the scope of this disclosure. For example, a device that reads bar codes may include a card reader, and/or RFID reader; a device that reads RFID tags may also be able to read bar codes and/or cards; and a device that reads cards may be able to also read bar codes and/or RFID. For further clarity, the primary function of a device may involve any of these functions in order to be considered such a device; for example, a cellular telephone, smartphone, or PDA that is capable of reading bar codes or RFID tags is a device that reads bar codes or RFID tags for purposes of this disclosure.

The EIR device 428 may be configured to read RFID tags and acquire different types of information, for example, backscattered phase information as described herein and communicate such information to the microprocessor 402 or memory 404. In another embodiment, the EIR device 428 can be configured to adjust the RFID transmit power level. Signals transmitted from or received by the RFID apparatus 200 may be provided via an antenna 430.

In some embodiments, the RFID apparatus 200 includes an inertial measurement unit (IMU) 432 (containing one or more of a 3-axis accelerometer, a 3-axis magnetometer and a 3-axis gyroscope sensor which may provide orientation information) utilized to record the position of the RFID apparatus 200 in three dimensional space. The IMU 432 also assists the RFID apparatus 200 in determining the orientation thereof, during the process of scanning for RFID tags as the RFID apparatus 200 moves through space. The orientation of the RFID apparatus 200 includes the position of the RFID apparatus 200 itself relative to a physical structure.

The RFID apparatus 200 can be at a given position, for example (x₁, y₁, z₁) but the orientation of the RFID apparatus at this position may vary. The RFID apparatus 200 may be held upright at a position to define one orientation, but the RFID apparatus 200 may also be moved to an angle relative to any direction in three dimensional space (while the position of the RFID apparatus 200 is unchanged). This movement represents a change in orientation. In one embodiment, during the scanning process, both the position and the orientation of the RFID apparatus 200 are calculated by the camera system 412 and/or the IMU 432 and the resultant data is stored and may be used to facilitate locating an item 130 (shown in FIG. 1) or positioning the RFID apparatus 200 as described in more detail herein.

As described herein, various embodiments allow for retuning of one or more antennas based on the known electrical properties of the particular peripheral device 150 connected to the system. For example, as shown in FIG. 5, the system 100, configured as an RFID apparatus 200 is coupled with the vehicle dock 500 within a cradle 502 of the vehicle dock 500. The vehicle dock 500 has certain electrical properties that can cause detuning of the RFID apparatus 200 when coupled with the vehicle dock 500 that may be determined, for example, through testing. For example, the RFID apparatus 200 may be coupled with plural different peripheral devices 150 (shown in FIG. 1), which may include one or more being coupled with the RFID apparatus 200 at one time, with testing of the transmission characteristics of one or more antennas, such as the transmit or receive antennas 104, 108, performed using one or more transmission testing methods in the art.

Thus, by performing this testing, a determination can be made, for example, as to how the peripheral device 150 will change the operating frequency of one of more antennas. As such, with knowledge of the operating frequency change that will occur when the peripheral device 150 is coupled with the system 100, one or more tuning options may be provided by the plural matching networks 114 for that particular peripheral device 150. Because precise measurements may be performed during the testing, increased accuracy is provide in retuning of the antenna(s) compared with auto-tuning systems.

Accordingly, based on the determined detuning effects, one or more of the matching networks 114 (shown in FIG. 1) is configured such that when connected, for example with the transmit and/or receive antennas 104, 108 by switching on the configured matching network 114, the detuning effects are reduced or eliminated by adding the matching network 114 into the antenna path. Accordingly, the transmit and/or receive antennas 104, 108 is retuned such that normal communication without degradation may be provided while the RFID apparatus 200 is coupled with the mobile dock 500. Thus, in operation, one or more of the matching networks 114, which may be preconfigured matching circuits, is switched on based on the identified peripheral device 150 and prior knowledge of the electrical properties and detuning effects caused by the peripheral device 150.

The controller 110 (shown in FIG. 1) in various embodiments can accurately and precisely control the detuning effects caused by the peripheral devices by switching on or off one or more of the matching networks 114. By dynamically controlling switching on and off of the one or more of the matching networks 114, the resonance of antennas may be changed to retune the antennas to within an acceptable performance operating range.

It should be appreciated that various embodiments may be implemented in connection with one or more antennas. For example, in some embodiments, each antenna can be tuned by a software controlled matching circuit corresponding to one or more of the matching networks 114 to allow for fine tuning of the antennas to intended or desired frequencies. As discussed herein, each of the peripheral devices 150 can have a “ID device” that provides a unique identification for the particular type of peripheral device 150, with for example the communication device 154 of the system 100 serving as the “reading device” and the identification component 152 serving as the “ID device.” For example, the communication device 154 may be an NFC radio, Bluetooth radio, camera, or imager on the mobile computing device, such as the system 100. In the example of a NFC radio as discussed herein, a NFC tag will be installed on each peripheral device 150 and operate as the ID device. As other examples, a Bluetooth chip or a barcode label can be installed to support Bluetooth or optical identification.

In general, and in accordance with various embodiments, when attached to a mobile computing device, the “reading device” collects the information from “ID device” and provides the knowledge of the peripheral device 150. The knowledge will then be used by the mobile computing device's operating system to control the matching circuit 114 of the antennas to optimally tune the antennas with the presence of the peripheral devices 150, such as when coupled to the system 100 or RFID apparatus 200.

Thus, in various embodiments, one or more antennas of a mobile computing device may be precisely and dynamically retuned to accommodate or compensate for the detuning effects of the peripheral device coupled to the mobile computing device.

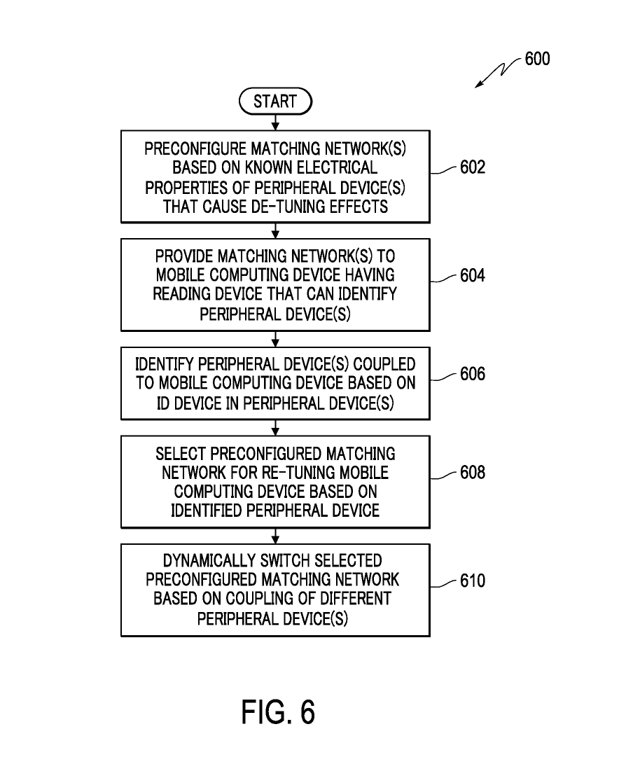

One or more embodiments include a method 600 as illustrated in FIG. 6. With reference also to FIGS. 1-5, the method 600 may be implemented or performed using one or more systems described herein, such as the system 100 and/or RFID apparatus 200. It should be noted that the steps of the method 600 may be performed in a different order and some steps may be performed concurrently. Additionally, some steps may be repeated.

The method 600 includes preconfiguring one or more matching networks at 602 based on the known electrical properties of one of more peripheral devices that may be coupled with a mobile computing device and cause detuning of the mobile computing device. For example, as described herein, plural peripheral devices 150 may be coupled to the system 100 and/or RFID apparatus 200 and the transmission characteristics (e.g., operating frequency) of the mobile computing device measured or monitored to determine the detuning effect caused when the peripheral device(s) 150 are coupled with the system 100 and/or RFID apparatus 200. As described herein, the detuning effects may include a frequency change or shift resulting from the electrical properties of the peripheral device 150 to be attached thereto. However, it should be appreciated that other detuning effects may be measured or monitored and used to preconfigure the one or more matching circuits 114.

Additionally, the preconfiguring of the one or more matching circuits 114 may include forming or constructing one or more tuning or matching circuits that retune one or more antennas of the mobile computing device based on the determined detuning effects. It should be appreciated that in some embodiments, a separate testing process may be performed for each combination of different mobile computing device and peripheral device that may be coupled or be compatible with the mobile computing device. As discussed herein, the matching networks 114 are configured to retune the mobile computing device based on a particular peripheral device 150. Thus, accurate retuning may be provided unlike auto-tuning systems. Accordingly, the matching networks 114 of the system 100 in various embodiments are configured as a non-auto-tuner circuits.

The method 600 also includes providing the one or more matching networks, such as the matching networks 114 to the mobile computing device at 604. For example, the matching networks 114 may be installed as part of the manufacturing process of the mobile computing device or may be installed after manufacturing, such as part of an add-on or kit. It should be appreciated that in either case, detuning information may be updated or added based on changes to the peripheral devices 150 or based on new peripheral devices 150 that may be coupled with the mobile computing device.

Additionally, as discussed herein, the mobile computing device also includes a reading device, such as the communication device 154, that can identify the particular peripheral device 150 coupled to the mobile computing device. The reading device may form part of already existing reading devices within the mobile computing device or may be added for the particular applications described herein. The reading device may be any type of device that communicates with or is able to scan the peripheral device 150 to identify the peripheral device 150.

The method 600 also includes identifying one or more peripheral devices 150 coupled to the mobile computing device at 606. For example, as described herein, the mobile computing device in some embodiments uses the reading device to read identification information from the ID device within the peripheral device(s) 150 coupled to the mobile computing device. The identification information may be any information that allows for the identification of the specific peripheral device 150, such as the make, model, version, etc. of the peripheral device 150.

The method 608 additionally includes selecting one of the preconfigured matching networks, such as one or more of the plural matching networks 114 for retuning the mobile computing device based on the identified peripheral device 150 coupled to the mobile computing device. For example, one or more of the matching networks 114 may be turned on or off to change the resonance of one or more antennas within the mobile computing device to maintain a radiation efficiency of the one or more antennas. The selection of the one or more matching circuits 114 may be performed dynamically, for example as different peripheral devices 150 are coupled to and decoupled from the mobile computing device 150, which may include accessing a database of peripheral device detuning information stored in the memory 120 (based on the detuning testing measurements). Thus, the method 600 can include dynamically switching on or off one or more of the matching networks 114 based on the current coupling of one or more peripheral devices 150 to the mobile computing device at 610.

It should be noted that the system 100 can comprise one or more microprocessors (which may be embodied as the processor 112) and a memory, such as the memory 120, coupled via a system bus. The microprocessor can be provided by a general purpose microprocessor or by a specialized microprocessor (e.g., an ASIC). In one embodiment, the system can comprise a single microprocessor which can be referred to as a central processing unit (CPU). In another embodiment, the system 100 can comprise two or more microprocessors, for example, a CPU providing some or most of the scanning functionality and a specialized microprocessor performing some specific functionality, such as to determine distance information and correlate that information with the acquired image information. A skilled artisan would appreciate the fact that other schemes of processing tasks distribution among two or more microprocessors are within the scope of this disclosure. The memory can comprise one or more types of memory, including but not limited to: random-access-memory (RAM), non-volatile RAM (NVRAM), etc.

It should be noted that, for example, the various embodiments can provide communication using different standards and protocols. For example, the wireless communication can be configured to support, for example, but not limited to, the following protocols: at least one protocol of the IEEE 802.11/802.15/802.16 protocol family, at least one protocol of the HSPA/GSM/GPRS/EDGE protocol family, TDMA protocol, UMTS protocol, LTE protocol, and/or at least one protocol of the CDMA/IxEV-DO protocol family.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The corresponding structures, materials, acts, and equivalents of any means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments in the form disclosed. Many modifications and variations will be apparent to those of ordinary skill in the art without departing from the scope and spirit of embodiments of the disclosure. The embodiments were chosen and described in order to best explain the principles of embodiments and practical application, and to enable others of ordinary skill in the art to understand embodiments with various modifications as are suited to the particular use contemplated.

The foregoing descriptions of specific embodiments have been presented for purposes of illustration and description. They are not intended to be exhaustive or to limit the embodiments to the precise forms disclosed, and obviously many modifications and variations are possible in light of the above teaching. The embodiments were chosen and described in order to best explain principles and practical applications thereof, and to thereby enable others skilled in the art to best utilize the various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims. The following claims are in no way intended to limit the scope of embodiments to the specific embodiments described herein.

What is claimed is:

1. A system comprising:
at least one antenna;
at least one matching network configured to retune the at least one antenna when a peripheral device is coupled to the system; and
a controller that controls switching of the at least one matching network based on the peripheral device when the peripheral device is coupled with the system.

2. The system of claim 1, further comprising plural matching networks, each of the matching networks configured to retune the at least one antenna based on one or more detuning effects of plural different peripheral devices.

3. The system of claim 2, wherein the controller is configured to dynamically switch between one or more of the plural matching networks.

4. The system of claim 1, wherein the at least one matching network is preconfigured to retune the system based on prior knowledge of the detuning effects of the peripheral device.

5. The system of claim 1, wherein the at least one matching network is a non-auto-tuner circuit.

6. The system of claim 1, wherein the at least one matching network comprises at least one of a capacitor or an inductor.

7. The system of claim 1, wherein the at least one matching network comprises at least one of a transmission line, a parasitic element, a grounding structure or a microchip.

8. The system of claim 1, further comprising a communication device and a processor, wherein the processor is configured to use peripheral device identification information acquired by the communication device from the peripheral device to identify the peripheral device.

9. The system of claim 8, wherein the communication device comprises at least one of a Near-Field Communication (NFC) radio, a Bluetooth radio, a camera or an imager.

10. The system of claim 8, wherein the peripheral device includes an identification component readable by the communication device or capable of sending the identification information to the communication device.

11. The system of claim 10, wherein the identification component comprises at least one of a Near-Field Communication (NFC) tag, a Bluetooth Low Energy chip or an optical device.

12. A mobile computing device comprising:
at least one antenna;
at least one non-auto-tuning device configured to retune the at least one antenna when a peripheral device is coupled to the system; and
a controller that controls the at least one non-auto-tuning device based on the peripheral device when the peripheral device is coupled with the system.

13. The mobile computing device of claim 12, wherein the at least one non-auto-tuning device is formed without capacitors or inductors.

14. The mobile computing device of claim 12, wherein the processor is configured to perform RFID reading operations.

15. A method for retuning a mobile computing device, the method comprising:
providing plural preconfigured matching networks with the mobile computing device, the plural preconfigured matching networks configured based on one or more known electrical properties of one or more peripheral devices to be coupled to the mobile computing device that detune the mobile computing device; and
configuring a controller within the mobile computing device to identify a peripheral device coupled to the mobile computing device and select one or more of the plural matching networks based on the identified peripheral device to retune one or more antennas within the mobile computing device when the peripheral device is coupled with the mobile computing device.

16. The method of claim 15, further comprising dynamically switching between one or more of the plural matching networks based on the peripheral device coupled with mobile computing device.

17. The method of claim 15, further comprising configuring the preconfigured plural matching networks using measured detuning test results for specific peripheral devices that may be coupled to the mobile computing device.

18. The method of claim 15, wherein configuring the controller within the mobile computing device to identify the peripheral device comprises using one of a Near-Field Communication (NFC) tag arrangement, a Bluetooth Low Energy chip arrangement or an optical device arrangement to identify the peripheral device.

19. The method of claim 15, wherein providing plural preconfigured matching networks comprises forming each of the plural preconfigured matching networks to retune the mobile computing device for only one peripheral device.

20. The method of claim 15, wherein providing plural preconfigured matching networks comprises forming each of the plural preconfigured matching networks to retune the mobile computing device for a plurality of peripheral devices.
